(19) United States
(12) Patent Application Publication
(10) Pub. No.: US 2026/0041135 A1
(43) Pub. Date: Feb. 12, 2026

(54) TARGET-ORIENTED FLAVOR EDITING METHOD AND SYSTEM FOR MAINTAINING CHARACTERISTIC FLAVOR OF FOOD

(71) Applicant: Institute of Food Science and Technology, Chinese Academy of Agricultural Sciences, Beijing (CN)

(72) Inventors: Chunhui ZHANG, Beijing (CN); Ping YANG, Beijing (CN); Wensong WEI, Beijing (CN)

(21) Appl. No.: 19/290,509

(22) Filed: Aug. 5, 2025

(30) Foreign Application Priority Data
Aug. 8, 2024 (CN) 2024110826990

(51) Int. Cl. A23L 35/00

(52) U.S. Cl. CPC A23L 35/00; A23V 2002/00

(57) ABSTRACT

A target-oriented flavor editing method and system for maintaining characteristic flavor of food. The method comprises: monitoring change in characteristic flavor profile of food exceeding a preset threshold to determine the occurrence of flavor profile shifting, and invoking an analysis model of flavor profile shifting paths to determine the flavor profile shifting path that causes flavor profile shifting; invoking a corresponding target-oriented flavor editing model based on the flavor profile shifting path, and outputting a target-oriented flavor editing scheme for maintaining flavor for the corresponding flavor profile shifting path; integrating the target-oriented flavor editing schemes output by the target-oriented flavor editing model corresponding to the flavor profile shifting paths, respectively, to obtain an integration result of the target-oriented flavor editing schemes; and performing flavor editing on food based on the integration result of the target-oriented flavor editing schemes.

### TECHNICAL FIELD

The present application relates to the technical field of chemical informatics, particularly to a target-oriented flavor editing method and system for maintaining characteristic flavor of food.

### BACKGROUND

Flavor is the soul of food, and the loss of characteristic flavor and the control of off-flavor generation are common key technical issues for maintaining characteristic flavor in traditional food industrialization. The food processing technology is diverse, the matrix composition is complex, the flavor analysis methods and procedures are cumbersome and time-consuming, and the analysis of the generation/loss path of characteristic flavor substances is difficult, resulting in unclear reasons for flavor deterioration in food processing/storage and transportation/reheating processes.

The existing technology mostly relies on subjective experience to determine the reasons for the flavor deterioration of food and make corresponding process adjustments, which cannot achieve precise, highly efficient, and intelligent target-oriented regulation of characteristic flavor of food, with poor effect of maintaining characteristic flavor of food.

### SUMMARY OF THE DISCLOSURE

The present application provides a target-oriented flavor editing method and system for maintaining characteristic flavor of food, which solves the shortcomings of the existing technology that cannot achieve precise, highly efficient, and intelligent target-oriented regulation of characteristic flavor of food, with poor effect of maintaining characteristic flavor of food, achieves precise, highly efficient, and intelligent target-oriented regulation of characteristic flavor of food, and improves the effect of maintaining characteristic flavor of food.

The present application provides a target-oriented flavor editing method for maintaining characteristic flavor of food, comprising the following steps: in response to monitoring that change in characteristic flavor profile of food exceeds a preset threshold, determining the occurrence of flavor profile shifting, and invoking an analysis model of flavor profile shifting paths to determine at least one flavor profile shifting path that causes flavor profile shifting; invoking a corresponding target-oriented flavor editing model, respectively, based on each flavor profile shifting path of the at least one flavor profile shifting path, and outputting a target-oriented flavor editing scheme for maintaining flavor for the corresponding flavor profile shifting path, respectively; integrating the target-oriented flavor editing schemes output by the target-oriented flavor editing model corresponding to the at least one flavor profile shifting path, respectively, to obtain an integration result of the target-oriented flavor editing schemes; and performing flavor editing on the food based on the integration result of the target-oriented flavor editing schemes.

According to a target-oriented flavor editing method for maintaining characteristic flavor of food provided by the present application, said invoking an analysis model of flavor profile shifting paths to determine at least one flavor profile shifting path that causes flavor profile shifting, comprising: obtaining model input data, wherein the model input data includes material list data, processing method data, and data of change in the type and amount of compounds before and after flavor profile shifting of the food; and loading the analysis model of flavor profile shifting paths, inputting the model input data into the analysis model of flavor profile shifting paths, and determining at least one flavor profile shifting path that causes flavor profile shifting based on an output result of the analysis model of flavor profile shifting paths.

According to a target-oriented flavor editing method for maintaining characteristic flavor of food provided by the present application, said invoking a corresponding target-oriented flavor editing model, respectively, based on each flavor profile shifting path of the at least one flavor profile shifting path, and outputting a target-oriented flavor editing scheme for maintaining flavor for the corresponding flavor profile shifting path, respectively, comprising: loading the target-oriented flavor editing model corresponding to the flavor profile shifting path, respectively, based on each flavor profile shifting path of the at least one flavor profile shifting path, inputting the model input data into the target-oriented flavor editing model, respectively, and obtaining a target-oriented flavor editing scheme for maintaining flavor for the corresponding flavor profile shifting path, respectively, based on the output of the target-oriented flavor editing model.

According to a target-oriented flavor editing method for maintaining characteristic flavor of food provided by the present application, the method further comprises: obtaining first input data and first output data based on a food sample that has undergone flavor deterioration, wherein the first input data includes material list data, processing method data, data of change in the type and amount of compounds before and after flavor profile shifting, and preselected flavor profile shifting feature descriptors of the food sample, and wherein the first output data includes the flavor profile shifting path of the food sample; using the first input data as the input of a first machine learning model, setting the output label of the first machine learning model based on the first output data, and iteratively training the first machine learning model; and stopping training when the preset number of iterations is reached or the preset accuracy requirement for predicting the flavor profile shifting path is met, to obtain the analysis model of flavor profile shifting paths.

According to a target-oriented flavor editing method for maintaining characteristic flavor of food provided by the present application, when the flavor profile shifting path is flavor escape, the corresponding target-oriented flavor editing model is a flavor escape correction editing model, the method further comprises: obtaining second input data and second output data based on a food sample that has undergone flavor escape, wherein the second input data includes material list data, processing method data, data of change in the type and amount of compounds before and after flavor escape, and preselected flavor escape feature descriptors of the food sample, and wherein the second output data includes flavor escape correction editing schemes for maintaining characteristic flavor of the food sample; using the second input data as the input of a second machine learning model, setting the output label of the second machine learning model based on the second output data, and iteratively training the second machine learning model; and stopping training when the preset number of iterations is reached or the preset characteristic flavor retention requirement is met, to obtain the flavor escape correction editing model.

According to a target-oriented flavor editing method for maintaining characteristic flavor of food provided by the present application, when the flavor profile shifting path is flavor inactivation, the corresponding target-oriented flavor editing model is a flavor inactivation correction editing model, the method further comprises: obtaining third input data and third output data based on a food sample that has undergone flavor inactivation, wherein the third input data includes material list data, processing method data, data of change in the type and amount of compounds before and after flavor inactivation, and preselected flavor inactivation feature descriptors of the food sample, and wherein the third output data includes flavor inactivation correction editing schemes for maintaining characteristic flavor of the food sample; using the third input data as the input of a third machine learning model, setting the output label of the third machine learning model based on the third output data, and iteratively training the third machine learning model; and stopping training when the preset number of iterations is reached or the preset characteristic flavor retention requirement is met, to obtain the flavor inactivation correction editing model.

According to a target-oriented flavor editing method for maintaining characteristic flavor of food provided by the present application, when the flavor profile shifting path is off-flavor generation, the corresponding target-oriented flavor editing model is an off-flavor generation correction editing model, the method further comprises: obtaining fourth input data and fourth output data based on a food sample that has undergone off-flavor generation, wherein the fourth input data includes material list data, processing method data, data of change in the type and amount of compounds before and after off-flavor generation, and preselected off-flavor generation feature descriptors of the food sample, and wherein the fourth output data includes off-flavor generation correction editing schemes for maintaining characteristic flavor of the food sample; using the fourth input data as the input of a fourth machine learning model, setting the output label of the fourth machine learning model based on the fourth output data, and iteratively training the fourth machine learning model; and stopping training when the preset number of iterations is reached or the preset characteristic flavor retention requirement is met, to obtain the off-flavor generation correction editing model.

According to a target-oriented flavor editing method for maintaining characteristic flavor of food provided by the present application, after performing flavor editing on the food based on the integration result of the target-oriented flavor editing schemes, the method further comprises: obtaining a flavor editing result and displaying.

The present application further provides a target-oriented flavor editing system for maintaining characteristic flavor of food, the system comprising: a drift path analysis module, which is used for: in response to monitoring that change in characteristic flavor profile of food exceeds a preset threshold, determining the occurrence of flavor profile shifting, and invoking an analysis model of flavor profile shifting paths to determine at least one flavor profile shifting path that causes flavor profile shifting; a flavor editing scheme output module, which is used for: invoking a corresponding target-oriented flavor editing model, respectively, based on each flavor profile shifting path of the at least one flavor profile shifting path, and outputting a target-oriented flavor editing scheme for maintaining flavor for the corresponding flavor profile shifting path, respectively; an integration module, which is used for: integrating the target-oriented flavor editing schemes output by the target-oriented flavor editing model corresponding to the at least one flavor profile shifting path, respectively, to obtain an integration result of the target-oriented flavor editing schemes; and a flavor editing module, which is used for: performing flavor editing on the food based on the integration result of the target-oriented flavor editing schemes.

The present application further provides an electronic device, comprising a memory, a processor, and a computer program stored on the memory and executable on the processor. When the processor executes the program, any of the target-oriented flavor editing method for maintaining characteristic flavor of food as described above is implemented.

The present application further provides a non transient computer-readable storage medium, on which a computer program is stored. When the computer program is executed by a processor, any of the target-oriented flavor editing method for maintaining characteristic flavor of food as described above is implemented.

The present application further provides a computer program product, comprising a computer program. When the computer program is executed by a processor, any of the target-oriented flavor editing method for maintaining characteristic flavor of food as described above is implemented.

In the target-oriented flavor editing method and system for maintaining characteristic flavor of food provided by the present application, in response to monitoring change in characteristic flavor profile of food exceeding a preset threshold, the occurrence of flavor profile shifting is determined, an analysis model of flavor profile shifting paths is invoked to determine at least one flavor profile shifting path that causes flavor profile shifting, a corresponding target-oriented flavor editing model is invoked, respectively, based on each flavor profile shifting path of the at least one flavor profile shifting path, a target-oriented flavor editing scheme for maintaining flavor for the corresponding flavor profile shifting path is output, respectively, the target-oriented flavor editing schemes output by the target-oriented flavor editing model corresponding respectively to the at least one flavor profile shifting path are integrated, to obtain an integration result of the target-oriented flavor editing schemes, and flavor editing is performed on the food based on the integration result of the target-oriented flavor editing schemes, thereby, achieving precise, highly efficient, and intelligent target-oriented regulation of characteristic flavor of food is achieved, and improving the effect of maintaining characteristic flavor of food.

### BRIEF DESCRIPTION OF THE DRAWINGS

In order to more clearly illustrate the technical solutions of the present application or the prior art, a brief introduction will be given to the accompanying drawings required for description of the examples or the prior art. It is obvious that the accompanying drawings described below are a part of the examples of the present application, and for those skilled in the art, other drawings can be obtained based on these accompanying drawings without creative labor.

FIG. 1 is one of the schematic flow diagrams of the target-oriented flavor editing method for maintaining characteristic flavor of food provided by the present application.

FIG. 2 is a second schematic flow diagram of the target-oriented flavor editing method for maintaining characteristic flavor of food provided by the present application.

FIG. 3 is a schematic diagram of the construction process of the target-oriented flavor editing model in the target-oriented flavor editing method for maintaining characteristic flavor of food provided by the present application.

FIG. 4 is a characteristic flavor profile map before target-oriented flavor editing in the target-oriented flavor editing method for maintaining characteristic flavor of food provided by the present application.

FIG. 5 is a characteristic flavor profile map after target-oriented flavor editing in the target-oriented flavor editing method for maintaining characteristic flavor of food provided by the present application.

FIG. 6 is a schematic diagram of the off-flavor values before and after target-oriented flavor editing in the target-oriented flavor editing method for maintaining characteristic flavor of food provided by the present application.

FIG. 7 is a schematic diagram of the structure of the target-oriented flavor editing system for maintaining characteristic flavor of food provided by the present application.

FIG. 8 is a schematic diagram of the structure of the electronic device provided by the present application.

### SPECIFIC MODES FOR CARRYING OUT THE EMBODIMENTS

In order to clarify the purpose, technical solution, and advantages of the present application, the technical solution of the present application will be described clearly and completely in conjunction with the accompanying drawings. Obviously, the described Examples are a part of the Examples, not all of the Example of the present application. Based on the Examples of the present application, all other Examples obtained by a person skilled in the art without creative effort are within the scope of protection of the present application.

Solving the 3W problems of “who is lost (Who), why is it lost (Why), and what pathways to solve (What)” during food processing/storage and transportation/reheating process is of great significance for achieving flavor regulation in traditional food industrialization. In terms of solutions of determining “who is lost (Who)”, molecular sensory science and technology is often used. This method can clarify the flavor composition or characteristics of food at the molecular level, achieve accurate qualitative and quantitative determination of key flavor active substances in food, and clarify change in the type and content of key flavor active substances that cause flavor profile shifting. In terms of solutions of analyzing “why is it lost (Why)”, the majority is due to the different distribution coefficients of specific flavor substances between air phase and matrix continuous phase, or change in the type and magnitude of physical and chemical acting forces such as encapsulation, adsorption, hydrophobic, and van der Waals forces between main matrices such as proteins, lipids, and carbohydrates, resulting in flavor loss through different paths such as flavor escape and flavor inactivation. In terms of providing solutions of “what pathways to solve (What)”, flavor loss is controlled mainly by adjusting processing technology and storage conditions, controlled release and slow release are achieved by embedding technologies such as microencapsulation and cyclodextrin, and flavor compensation is achieved by adding spices, condiments, essence, and the like.

The present application provides a target-oriented flavor editing method based on big data analysis, artificial intelligence algorithm modeling, and multi-level grid path optimization, which can qualitatively and quantitatively enhance flavor, compensate flavor, and correct off-flavor, is a key means for systematically integrating the 3W problems of “who is lost (Who), why is it lost (Why), and what pathways to solve (What)” during food processing/storage and transportation/reheating process, and is also an effective way to achieve intelligent targeted regulation of maintaining characteristic flavor of food, with a characteristic flavor retention of over 90%.

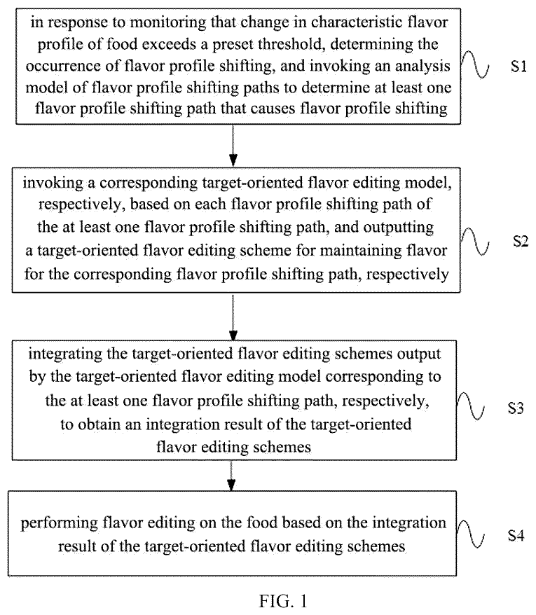

FIG. 1 is one of the schematic flow diagrams of the target-oriented flavor editing method for maintaining characteristic flavor of food provided by the present application. As shown in FIG. 1, the method comprises:

Step S1: in response to monitoring that change in characteristic flavor profile of food exceeds a preset threshold, determining the occurrence of flavor profile shifting, and invoking an analysis model of flavor profile shifting paths to determine at least one flavor profile shifting path that causes flavor profile shifting.

Sensory evaluation, electronic nose, or handheld mass spectrometer and the like can be used as sensors to monitor the characteristic flavor profile of food online. If the monitored change in the characteristic flavor profile of the food exceeds a preset threshold, it indicates that flavor profile shifting has occurred. By invoking a pretrained flavor profile shifting path analysis model, at least one flavor profile shifting path that causes flavor profile shifting can be determined. Flavor profile shifting paths include flavor escape, flavor inactivation, and off-flavor generation. Due to the fact that flavor profile shifting of food may be caused by one or two or more flavor profile shifting paths, the flavor profile shifting path determined by the flavor profile shifting path analysis model is at least one, i.e., including one or two or more flavor profile shifting paths.

Step S2: invoking a corresponding target-oriented flavor editing model, respectively, based on each flavor profile shifting path of the at least one flavor profile shifting path, and outputting a target-oriented flavor editing scheme for maintaining flavor for the corresponding flavor profile shifting path, respectively.

For each flavor profile shifting path, a corresponding target-oriented flavor editing model is pretrained to perform target-oriented flavor editing for this flavor profile shifting path for maintaining flavor. Based on the circumstance of at least one flavor profile shifting path determined by the flavor profile shifting path analysis model, for each flavor profile shifting path therein, a corresponding target-oriented flavor editing model is invoked, respectively, thereby outputting a target-oriented flavor editing scheme for maintaining flavor for the corresponding flavor profile shifting path, respectively. The target-oriented flavor editing schemes output by the target-oriented flavor editing model can not necessarily be limited to one, but can also be two or more. When there are two or more target-oriented flavor editing schemes output by the target-oriented flavor editing model, one of them can be selected to perform target-oriented flavor editing of the target-oriented flavor profile shifting path. That is to say, the output results of the target-oriented flavor editing model can be in the form of A or B or C, wherein A, B and C represent different target-oriented flavor editing schemes.

Step S3: integrating the target-oriented flavor editing schemes output by the target-oriented flavor editing model corresponding to the at least one flavor profile shifting path, respectively, to obtain an integration result of the target-oriented flavor editing schemes.

It can be understood that if the flavor profile shifting path analysis model only outputs one flavor profile shifting path, then an integration result of the target-oriented flavor editing schemes is obtained, only based on the target-oriented flavor editing schemes output by the target-oriented flavor editing model corresponding to the flavor profile shifting path. For example, if the target-oriented flavor editing scheme output by the target-oriented flavor editing model corresponding to this flavor profile shifting path is A or B or C, then one of A, B and C can be selected as the integration result of the target-oriented flavor editing scheme.

If the flavor profile shifting path analysis model outputs two or more flavor profile shifting paths, it is necessary to integrate the target-oriented flavor editing schemes output by the target-oriented flavor editing model corresponding to each flavor profile shifting path, respectively, to obtain an integration result of the target-oriented flavor editing schemes. For example, the flavor profile shifting path analysis model outputs two flavor profile shifting paths. If the target-oriented flavor editing scheme output by the target-oriented flavor editing model corresponding to the first flavor profile shifting path is A or B or C, and the target-oriented flavor editing scheme output by the target-oriented flavor editing model corresponding to the second flavor profile shifting path is D, then the integration result of the target-oriented flavor editing scheme can be determined as one of A+D, B+D, and C+D.

Step S4: performing flavor editing on the food based on the integration result of the target-oriented flavor editing schemes.

Flavor editing on the food is performed based on the integration result of the target-oriented flavor editing schemes. Performing flavor editing on the food based on the integration result of the target-oriented flavor editing schemes means processing the food based on the integration result of the target-oriented flavor editing schemes, to change the situation of flavor deterioration of the food and maintain characteristic flavor of the food.

In the target-oriented flavor editing method for maintaining characteristic flavor of food provided by the present application, in response to monitoring change in characteristic flavor profile of food exceeding a preset threshold, the occurrence of flavor profile shifting is determined, an analysis model of flavor profile shifting paths is invoked to determine at least one flavor profile shifting path that causes flavor profile shifting, a corresponding target-oriented flavor editing model is invoked, respectively, based on each flavor profile shifting path of the at least one flavor profile shifting path, a target-oriented flavor editing scheme for maintaining flavor for the corresponding flavor profile shifting path is output, respectively, the target-oriented flavor editing schemes output by the target-oriented flavor editing model corresponding respectively to the at least one flavor profile shifting path are integrated, to obtain an integration result of the target-oriented flavor editing schemes, and flavor editing is performed on the food based on the integration result of the target-oriented flavor editing schemes, thereby, achieving precise, highly efficient, and intelligent target-oriented regulation of characteristic flavor of food is achieved, and improving the effect of maintaining characteristic flavor of food.

According to a target-oriented flavor editing method for maintaining characteristic flavor of food provided by the present application, wherein said “invoking an analysis model of flavor profile shifting paths to determine at least one flavor profile shifting path that causes flavor profile shifting”, comprises: obtaining model input data, wherein the model input data includes material list data, processing method data, and data of change in the type and amount of compounds before and after flavor profile shifting of the food; and loading the analysis model of flavor profile shifting paths, inputting the model input data into the analysis model of flavor profile shifting paths, and determining at least one flavor profile shifting path that causes flavor profile shifting based on an output result of the analysis model of flavor profile shifting paths.

When invoking an analysis model of flavor profile shifting paths to determine at least one flavor profile shifting path that causes flavor profile shifting, model input data is obtained, wherein the model input data includes material list data (BOM table data), processing method data, and data of change in the type and amount of compounds before and after flavor profile shifting of the food. The analysis model of flavor profile shifting paths is loaded, the model input data is input into the analysis model of flavor profile shifting paths, and at least one flavor profile shifting path that causes flavor profile shifting is determined based on an output result of the analysis model of flavor profile shifting paths.

Wherein change in the type and amount of compounds before and after flavor profile shifting can be obtained through molecular sensory science and technology including GC-O-MS, AEDA dilution analysis, FD factor sorting, stable isotope dilution analysis (SIDA), OAV value calculation, aroma recombination deficiency experiments, and the like.

In the target-oriented flavor editing method for maintaining characteristic flavor of food provided by the present application, model input data, which includes material list data, processing method data, and data of change in the type and amount of compounds before and after flavor profile shifting of the food, is obtained, the analysis model of flavor profile shifting paths is loaded, the model input data is input into the analysis model of flavor profile shifting paths, and at least one flavor profile shifting path that causes flavor profile shifting is determined based on an output result of the analysis model of flavor profile shifting paths. By reasonably determining the input data of the analysis model of flavor profile shifting paths and invoking the model, the accuracy of flavor profile shifting path determination is improved.

According to the target-oriented flavor editing method for maintaining characteristic flavor of food provided by the present application, said “invoking a corresponding target-oriented flavor editing model, respectively, based on each flavor profile shifting path of the at least one flavor profile shifting path, and outputting a target-oriented flavor editing scheme for maintaining flavor for the corresponding flavor profile shifting path, respectively”, comprises: loading the target-oriented flavor editing model corresponding to the flavor profile shifting path, respectively, based on each flavor profile shifting path of the at least one flavor profile shifting path, inputting the model input data into the target-oriented flavor editing model, respectively, and obtaining a target-oriented flavor editing scheme for maintaining flavor for the corresponding flavor profile shifting path, respectively, based on the output of the target-oriented flavor editing model.

When invoking a corresponding target-oriented flavor editing model, respectively, based on each flavor profile shifting path of the at least one flavor profile shifting path, and outputting a target-oriented flavor editing scheme for maintaining flavor for the corresponding flavor profile shifting path, respectively, the target-oriented flavor editing model corresponding to the flavor profile shifting path is loaded, respectively, based on each flavor profile shifting path of the at least one flavor profile shifting path, the model input data is input into the target-oriented flavor editing model, respectively, and a target-oriented flavor editing scheme for maintaining flavor for the corresponding flavor profile shifting path is obtained, respectively, based on the output of the target-oriented flavor editing model, wherein the model input data includes material list data, processing method data, and data of change in the type and amount of compounds before and after flavor profile shifting of food.

In the target-oriented flavor editing method for maintaining characteristic flavor of food provided by the present application, the target-oriented flavor editing model corresponding to the flavor profile shifting path is loaded, respectively, based on each flavor profile shifting path of the at least one flavor profile shifting path, the model input data is input into the target-oriented flavor editing model, respectively, and a target-oriented flavor editing scheme for maintaining flavor for the corresponding flavor profile shifting path is obtained, respectively, based on the output of the target-oriented flavor editing model. By reasonably determining the input data of the target-oriented flavor editing model and invoking the model, the accuracy of flavor profile shifting path determination is improved.

According to a target-oriented flavor editing method for maintaining characteristic flavor of food provided by the present application, the method further comprises: obtaining first input data and first output data based on a food sample that has undergone flavor deterioration, wherein the first input data includes material list data, processing method data, data of change in the type and amount of compounds before and after flavor profile shifting, and preselected flavor profile shifting feature descriptors of the food sample, and wherein the first output data includes the flavor profile shifting path of the food sample; using the first input data as the input of a first machine learning model, setting the output label of the first machine learning model based on the first output data, and iteratively training the first machine learning model; and stopping training when the preset number of iterations is reached or the preset accuracy requirement for predicting the flavor profile shifting path is met, to obtain the analysis model of flavor profile shifting paths.

A machine learning model is trained based on a food sample that has undergone flavor deterioration, to obtain an analysis model of flavor profile shifting paths. First input data and first output data are obtained based on the food sample that has undergone flavor deterioration, wherein the first input data includes material list data, processing method data, data of change in the type and amount of compounds before and after flavor profile shifting, and preselected flavor profile shifting feature descriptors of the food sample, and wherein the first output data includes the flavor profile shifting path of the food sample.

The flavor profile shifting feature descriptor can be understood as data used to describe the flavor profile shifting feature of food that has undergone flavor deterioration. By calculating key reaction rates such as Maillard reaction and fat oxidation during processing/storage and transportation/reheating process, or based on results of multi-omics analysis such as proteomics, lipidomics, metabolomics, and flavoromics, or by analyzing the type and magnitude of acting forces such as the reversible interactions (hydrogen bonds, ionic bonds, van der Waals forces, hydrophobic interaction) and irreversible interactions (disulfide bond exchange, Schiff base addition, Michael addition) between flavor substances and main matrices of food such as proteins, lipids, and starch (sugar), or by extracting descriptors of molecular and atomic features such as the number of atoms, charge distribution, bond length, and bond angle, the flavor profile shifting paths [flavor loss (escape+inactivation)+off-flavor generation] can be determined to clarify the reasons for flavor deterioration. The flavor profile shifting feature descriptors can be obtained from the aforementioned flavor profile shifting related data.

The first input data is used as the input of the first machine learning model, the output label of the first machine learning model is set based on the first output data, the first machine learning model is iteratively trained, and when the preset number of iterations is reached or the preset accuracy requirement for predicting the flavor profile shifting path is met, the training is stopped to obtain the analysis model of flavor profile shifting paths, wherein the machine learning model can be artificial neural network, linear regression model, decision-making tree model, or the like.

It has been verified that when using a trained analysis model of flavor profile shifting paths for predicting flavor profile shifting paths, accurate prediction of flavor profile shifting paths can be achieved merely by inputting material list data, processing method data, and data of change in the type and amount of compounds before and after flavor escape. Due to the complexity of flavor profile shifting feature descriptors, after training to obtain an analysis model of flavor profile shifting paths, when using the analysis model of flavor profile shifting paths for prediction, the steps of constructing flavor profile shifting feature descriptors and inputting into the model can be omitted to improve processing efficiency.

In the target-oriented flavor editing method for maintaining characteristic flavor of food provided by the present application, first input data and first output data are obtained based on a food sample that has undergone flavor deterioration, wherein the first input data includes material list data, processing method data, data of change in the type and amount of compounds before and after flavor profile shifting, and preselected flavor profile shifting feature descriptors of the food sample, and wherein the first output data includes the flavor profile shifting path of the food sample. The first input data is used as the input of the first machine learning model, and the output label of the first machine learning model is set according to the first output data. The first machine learning model is iteratively trained, and the training is stopped when the preset number of iterations is reached or the preset accuracy requirement for predicting the flavor profile shifting path is met, to obtain the analysis model of flavor profile shifting paths. The prediction accuracy of the analysis model of flavor profile shifting paths is improved.

According to the target-oriented flavor editing method for maintaining characteristic flavor of food provided by the present application, when the flavor profile shifting path is flavor escape, the corresponding target-oriented flavor editing model is a flavor escape correction editing model. The method further comprises: obtaining second input data and second output data based on a food sample that has undergone flavor escape, wherein the second input data includes material list data, processing method data, data of change in the type and amount of compounds before and after flavor escape, and preselected flavor escape feature descriptors of the food sample, and wherein the second output data includes flavor escape correction editing schemes for maintaining characteristic flavor of the food sample; using the second input data as the input of a second machine learning model, setting the output label of the second machine learning model based on the second output data, and iteratively training the second machine learning model; and stopping training when the preset number of iterations is reached or the preset characteristic flavor retention requirement is met, to obtain the flavor escape correction editing model.

When training the flavor escape correction editing model, second input data and second output data are obtained based on a food sample that has undergone flavor escape, wherein the second input data includes material list data, processing method data, data of change in the type and amount of compounds before and after flavor escape, and preselected flavor escape feature descriptors of the food sample, wherein the second output data includes a flavor escape correction editing scheme for maintaining characteristic flavor of the food sample, and wherein the flavor escape feature descriptor can be selected from flavor escape related descriptors in flavor deterioration descriptors.

Characteristic flavor profile correction can be performed by flavor editing means such as flavor release control, flavor enhancement and flavor compensation, and off-flavor correction, to solve the problem of flavor profile shifting of food, wherein, 1) the endogenous editing scheme mainly includes: performing flavor editing by utilizing food material property/food flavor interaction, thermal reaction to produce aroma, changing food processing and reheating methods/conditions, controlling storage conditions or packaging materials, and the like; and 2) the exogenous editing scheme includes: performing flavor editing by flavoring with spices, antioxidant/intrinsic antioxidation control of essential oil, cyclodextrin/nanoparticle embedding, emulsion system slow release and the like. The second output data include flavor escape correction editing schemes for maintaining characteristic flavor of the food sample, that is, flavor editing means for flavor escape.

The second input data is used as the input of the second machine learning model, the output label of the second machine learning model is set based on the second output data, the second machine learning model is iteratively trained, and the training is stopped when the preset number of iterations is reached or the preset characteristic flavor retention requirement is met, to obtain a flavor escape correction editing model, wherein the second machine model can be set with multiple output terminals, each output terminal corresponding to a flavor escape correction editing scheme, and the label of the output terminal is set according to the specific flavor editing means for flavor escape of the food sample.

If the relationship between the second input data and the second output data is simple, the machine learning model can be a relatively simple regression model. If the relationship between the second input data and the second output data is complex and involves multi-layer factors, models such as deep neural networks can be used. The characteristic flavor retention requirement can be set as needed, for example, it is set to be greater than 90%. With the help of technologies such as sensory evaluation+GC-MS/GC-IMS/electronic nose and the like, an intelligent feedback regulation system for human-machine interaction of flavor wheel shifting/correction can be established, to achieve measurable flavor editing and real-time feedback of editing effects.

It has been verified that when using a trained flavor escape correction editing model to perform target-oriented flavor editing, accurate target-oriented flavor editing schemes can be given merely by inputting material list data, processing method data, and data of change in the type and amount of compounds before and after flavor escape. Due to the complexity of flavor escape feature descriptors, after training to obtain a flavor escape correction editing model, when using the flavor escape correction editing model for prediction, the steps of constructing flavor escape feature descriptors and inputting into the model can be omitted so as to improve processing efficiency.

In the target-oriented flavor editing method for maintaining characteristic flavor of food provided by the present application, second input data and second output data are obtained based on a food sample that has undergone flavor escape, wherein the second input data includes material list data, processing method data, data of change in the type and amount of compounds before and after flavor escape, and preselected flavor escape feature descriptors of the food sample, and wherein the second output data includes flavor escape correction editing schemes for maintaining characteristic flavor of the food sample. The second input data is used as the input of the second machine learning model, and the output label of the second machine learning model is set according to the second output data. The second machine learning model is iteratively trained, and the training is stopped when the preset number of iterations is reached or the preset characteristic flavor retention requirement is met, to obtain a flavor escape correction editing model, and thereby improving the accuracy of the flavor escape correction editing model.

According to a target-oriented flavor editing method for maintaining characteristic flavor of food provided by the present application, when the flavor profile shifting path is flavor inactivation, the corresponding target-oriented flavor editing model is a flavor inactivation correction editing model. The method further comprises: obtaining third input data and third output data based on a food sample that has undergone flavor inactivation, wherein the third input data includes material list data, processing method data, data of change in the type and amount of compounds before and after flavor inactivation, and preselected flavor inactivation feature descriptors of the food sample, and wherein the third output data includes flavor inactivation correction editing schemes for maintaining characteristic flavor of the food sample; using the third input data as the input of a third machine learning model, setting the output label of the third machine learning model based on the third output data, and iteratively training the third machine learning model; and stopping training when the preset number of iterations is reached or the preset characteristic flavor retention requirement is met, to obtain the flavor inactivation correction editing model.

When training the flavor inactivation correction editing model, third input data and third output data are obtained based on a food sample that has undergone flavor inactivation, wherein the third input data includes material list data, processing method data, data of change in the type and amount of compounds before and after flavor inactivation, and preselected flavor inactivation feature descriptors of the food sample, wherein the third output data includes flavor inactivation correction editing schemes for maintaining characteristic flavor of the food sample, and wherein the flavor inactivation feature descriptor can be selected from flavor inactivation related descriptors in flavor deterioration descriptors.

Characteristic flavor profile correction can be performed by flavor editing means such as flavor release control, flavor enhancement and flavor compensation, and off-flavor correction, to solve the problem of flavor profile shifting of food, wherein, 1) the endogenous editing scheme mainly includes: performing flavor editing by utilizing food material property/food flavor interaction, thermal reaction to produce aroma, changing food processing and reheating methods/conditions, controlling storage conditions or packaging materials, or the like; and 2) the exogenous editing scheme includes: performing flavor editing by flavoring with spices, antioxidant/intrinsic antioxidation control of essential oil, cyclodextrin/nanoparticle embedding, emulsion system slow release and the like. The third output data include flavor inactivation correction editing schemes for maintaining characteristic flavor of the food sample, that is, flavor editing means for flavor inactivation.

The third input data is used as the input of the third machine learning model, the output label of the third machine learning model is set based on the third output data, the third machine learning model is iteratively trained, and when the preset number of iterations is reached or the preset characteristic flavor retention requirement is met, the training is stopped to obtain a flavor inactivation correction editing model, wherein the third machine model can be set with multiple output terminals, each output terminal corresponding to a flavor inactivation correction editing scheme, and the label of the output terminal is set according to the specific flavor editing means for flavor inactivation of the food sample.

If the relationship between the third input data and the third output data is simple, the machine learning model can be a relatively simple regression model. If the relationship between the third input data and the third output data is complex and involves multi-layer factors, models such as deep neural networks can be used. The characteristic flavor retention requirement can be set as needed, for example, it is set to be greater than 90%. With the help of technologies such as sensory evaluation+GC-MS/GC-IMS/electronic nose and the like, an intelligent feedback regulation system for human-machine interaction of flavor wheel shifting/correction can be established, to achieve measurable flavor editing and real-time feedback of editing effects.

It has been verified that when using a trained flavor inactivation correction editing model to perform target-oriented flavor editing, accurate target-oriented flavor editing schemes can be given merely by inputting material list data, processing method data, and data of change in the type and amount of compounds before and after flavor inactivation. Due to the complexity of flavor inactivation feature descriptors, after training to obtain a flavor inactivation correction editing model, when using the flavor inactivation correction editing model for prediction, the steps of constructing flavor inactivation feature descriptors and inputting into the model can be omitted so as to improve processing efficiency.

In the target-oriented flavor editing method for maintaining characteristic flavor of food provided by the present application, third input data and third output data are obtained based on a food sample that has undergone flavor inactivation, wherein the third input data includes material list data, processing method data, data of change in the type and amount of compounds before and after flavor inactivation, and preselected flavor inactivation feature descriptors of the food sample, and wherein the third output data includes flavor inactivation correction editing schemes for maintaining characteristic flavor of the food sample. The third input data is used as the input of the third machine learning model, and the output label of the third machine learning model is set according to the third output data. The third machine learning model is iteratively trained, and the training is stopped when the preset number of iterations is reached or the preset characteristic flavor retention requirement is met, to obtain a flavor inactivation correction editing model, and thereby improving the accuracy of the flavor inactivation correction editing model.

According to a target-oriented flavor editing method for maintaining characteristic flavor of food provided by the present application, when the flavor profile shifting path is off-flavor generation, the corresponding target-oriented flavor editing model is an off-flavor generation correction editing model. The method further comprises: obtaining fourth input data and fourth output data based on a food sample that has undergone off-flavor generation, wherein the fourth input data includes material list data, processing method data, data of change in the type and amount of compounds before and after off-flavor generation, and preselected off-flavor generation feature descriptors of the food sample, and wherein the fourth output data includes off-flavor generation correction editing schemes for maintaining characteristic flavor of the food sample; using the fourth input data as the input of a fourth machine learning model, setting the output label of the fourth machine learning model based on the fourth output data, and iteratively training the fourth machine learning model; and stopping training when the preset number of iterations is reached or the preset characteristic flavor retention requirement is met, to obtain the off-flavor generation correction editing model.

When training the off-flavor generation correction editing model, fourth input data and fourth output data are obtained based on a food sample that has undergone off-flavor generation, wherein the fourth input data includes material list data, processing method data, data of change in the type and amount of compounds before and after off-flavor generation, and preselected off-flavor generation feature descriptors of the food sample, wherein the fourth output data includes off-flavor generation correction editing schemes for maintaining characteristic flavor of the food sample, and wherein the off-flavor generation feature descriptor can be selected from off-flavor generation related descriptors in flavor deterioration descriptors.

Characteristic flavor profile correction can be performed by flavor editing means such as flavor release control, flavor enhancement and flavor compensation, and off-flavor correction, to solve the problem of flavor profile shifting of food, wherein, 1) the endogenous editing scheme mainly includes: performing flavor editing by utilizing food material property/food flavor interaction, thermal reaction to produce aroma, changing food processing and reheating methods/conditions, controlling storage conditions or packaging materials, or the like; and 2) the exogenous editing scheme includes: performing flavor editing by flavoring with spices, antioxidant/essential oil intrinsic antioxidation control, cyclodextrin/nanoparticle embedding, emulsion system slow release and the like. The fourth output data include off-flavor generation correction editing schemes for maintaining characteristic flavor of the food sample, that is, flavor editing means for off-flavor generation.

The fourth input data is used as the input of the fourth machine learning model, the output label of the fourth machine learning model is set based on the fourth output data, the fourth machine learning model is iteratively trained, and when the preset number of iterations is reached or the preset characteristic flavor retention requirement is met, the training is stopped to obtain an off-flavor generation correction editing model, wherein the fourth machine model can be set with multiple output terminals, each output terminal corresponding to an off-flavor generation correction editing scheme, and the label of the output terminal is set according to the specific flavor editing means for off-flavor generation of the food sample.

If the relationship between the fourth input data and the fourth output data is simple, the machine learning model can be a relatively simple regression model. If the relationship between the fourth input data and the fourth output data is complex and involves multi-layer factors, models such as deep neural networks can be used. The characteristic flavor retention requirement can be set as needed, for example, it is set to be greater than 90%. With the help of technologies such as sensory evaluation+GC-MS/GC-IMS/electronic nose and the like, an intelligent feedback regulation system for human-machine interaction of flavor wheel shifting/correction can be established, to achieve measurable flavor editing and real-time feedback of editing effects.

It has been verified that when using a trained off-flavor generation correction editing model to perform target-oriented flavor editing, accurate target-oriented flavor editing schemes can be given merely by inputting material list data, processing method data, and data of change in the type and amount of compounds before and after off-flavor generation. Due to the complexity of off-flavor generation feature descriptors, after training to obtain an off-flavor generation correction editing model, when using the off-flavor generation correction editing model for prediction, the steps of constructing off-flavor generation feature descriptors and inputting into the model can be omitted so as to improve processing efficiency.

In the target-oriented flavor editing method for maintaining characteristic flavor of food provided by the present application, fourth input data and fourth output data are obtained based on a food sample that has undergone off-flavor generation, wherein the fourth input data includes material list data, processing method data, data of change in the type and amount of compounds before and after off-flavor generation, and preselected off-flavor generation feature descriptors of the food sample, and wherein the fourth output data includes off-flavor generation correction editing schemes for maintaining characteristic flavor of the food sample. The fourth input data is used as the input of the fourth machine learning model, and the output label of the fourth machine learning model is set according to the fourth output data. The fourth machine learning model is iteratively trained, and the training is stopped when the preset number of iterations is reached or the preset characteristic flavor retention requirement is met, to obtain an off-flavor generation correction editing model, and thereby improving the accuracy of the off-flavor generation correction editing model.

According to a target-oriented flavor editing method for maintaining characteristic flavor of food provided by the present application, after performing flavor editing on the food based on the integration result of the target-oriented flavor editing schemes, the method further comprises: obtaining a flavor editing result and displaying.

After performing flavor editing on the food based on the integration result of the target-oriented flavor editing schemes, a flavor editing result can be obtained and displayed. Flavor editing effects can be visualized using technologies such as GC-MS/GC-IMS/electronic nose. By combining sensory evaluation, an intelligent feedback regulation system for human-machine interaction of flavor wheel shifting/correction can be established, to achieve measurable flavor editing, verify the accuracy of target-oriented flavor editing effects of food, and achieve characteristic flavor retention. The content and output form of flavor editing results can be determined according to needs, for example, it can be represented by the change in the characteristic flavor profile map before and after flavor editing, the content of flavor active factors, and the like.

The target-oriented flavor editing method for maintaining characteristic flavor of food provided by the present application achieves visualization of flavor editing effects by obtaining and displaying flavor editing results after performing flavor editing on the food based on the integration result of target-oriented flavor editing schemes.

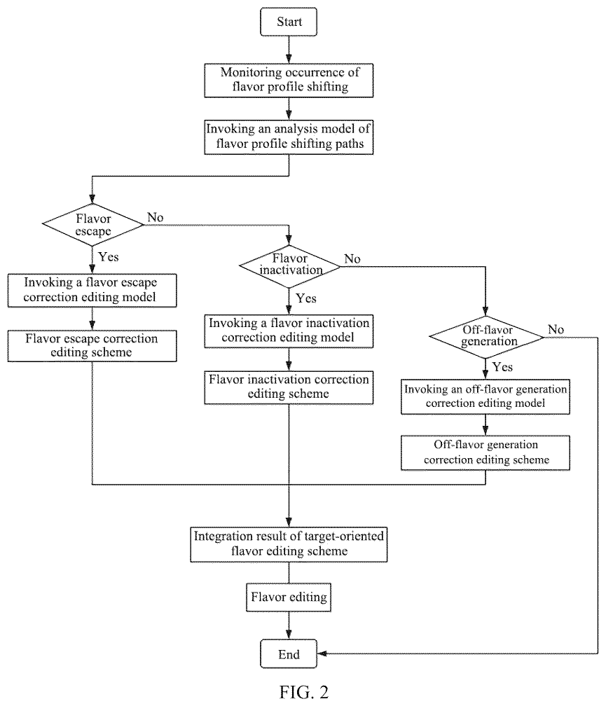

FIG. 2 is a second schematic flow diagram of the target-oriented flavor editing method for maintaining characteristic flavor of food provided by the present application. As shown in FIG. 2, the method comprises:
monitoring the occurrence of flavor profile shifting of food, and invoking an analysis model of flavor profile shifting paths;
determining whether the flavor profile shifting paths analyzed by the analysis model of flavor profile shifting paths include flavor escape, if the flavor profile shifting paths include flavor escape, invoking a flavor escape correction editing model, and outputting a flavor escape correction editing scheme;
if the flavor profile shifting paths do not include flavor escape, further determining whether the flavor profile shifting paths analyzed by the analysis model of flavor profile shifting paths include flavor inactivation, if the flavor profile shifting paths include flavor inactivation, invoking a flavor inactivation correction editing model, and outputting a flavor inactivation correction editing scheme;
if the flavor profile shifting paths do not include flavor inactivation, further determining whether the flavor profile shifting paths analyzed by the analysis model of flavor profile shifting paths include off-flavor generation, if the flavor profile shifting paths include off-flavor generation, invoking an off-flavor generation correction editing model, and outputting an off-flavor generation correction editing scheme;
integrating the output results of each target-oriented flavor editing model to obtain an integration result of target-oriented flavor editing schemes, and performing flavor editing on the food based on the integration result of target-oriented flavor editing schemes; and
ending if the flavor profile shifting paths do not include off-flavor generation.

It can be understood that the judgment order of whether the flavor profile shifting paths analyzed by the above analysis model of flavor profile shifting paths include flavor escape, flavor inactivation, and off-flavor generation can be flexibly adjusted.

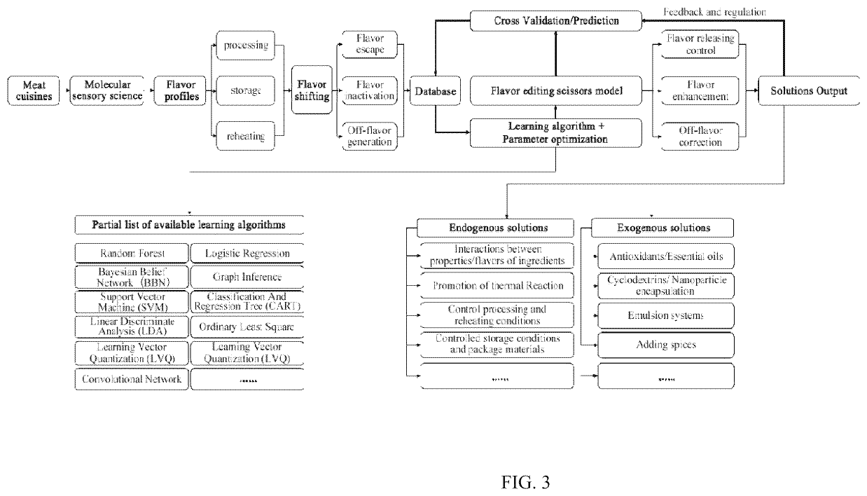

FIG. 3 is a schematic diagram of the construction process of the target-oriented flavor editing model in the target-oriented flavor editing method for maintaining characteristic flavor of food provided by the present application. As shown in FIG. 3, the flavor features of food can be determined through molecular sensory science and technology. During processing, storage and transportation, and reheating, food undergoes flavor profile shifting, flavor profile shifting paths including flavor escape, flavor inactivation, and off-flavor generation. For each flavor profile shifting path, corresponding feature descriptors are set and stored in a database. Based on material list data, processing method data, data of change in the type and amount of compounds before and after flavor escape, and corresponding feature descriptors of the food, a corresponding target-oriented flavor editing model is trained. In model training, multiple machine learning algorithms, such as random forest, logistic regression, and convolutional networks, can be used. Based on different flavor profile shifting paths, target-oriented flavor editing models output target-oriented flavor editing schemes for aroma release control, flavor enhancement, or off-flavor correction. The target-oriented flavor editing schemes include endogenous editing scheme and exogenous editing scheme. The endogenous editing scheme includes interaction between ingredient feature/flavor, promoting thermal reaction, and the like. The exogenous editing scheme includes addition of antioxidant/essential oil, addition of spices, and the like. After outputting target-oriented flavor editing schemes, model parameters are continuously optimized through feedback and regulation, cross validation, and the like, and finally, training is performed to obtain a performance optimized target-oriented flavor editing model for outputting target-oriented flavor editing schemes for different flavor profile shifting paths.

The following two specific cases further illustrate the target-oriented flavor editing method for maintaining characteristic flavor of food provided by the present application.

### Case 1: Flavor Loss Editing Method: Flavor Enhancement and Flavor Compensation

S1: Based on molecular sensory science and technology, the key aroma active compounds in stewed chicken soup were identified as: hexanal, heptanal, octanal, nonanal, 3-methylthiopropanal, decanal, (E, E)-2, 4-nonadienal, β-phellandrene, acetoin, linalool, citronellol, and geraniol. Simultaneously, a characteristic flavor profile map was obtained.
S2: After storage, the characteristic flavor profile map was used to judge the change in its characteristic flavor profile.
S3: An analysis model of flavor profile drifting paths was invoked to determine the flavor profile shifting path that causes flavor profile shifting as flavor escape.
S4: A flavor escape correction editing model was invoked for performing target-oriented flavor editing.
S5: Editing scheme output: 1) endogenous editing scheme: thermal reaction to produce aroma. Specifically, during stewing process, 0.3% to 0.5% of D-xylose, 0.5% to 0.6% of cysteine hydrochloride, and 0.3% to 0.5% of thiamine were added, pH being 6.7 to 6.9, optimizing formula; and 2) exogenous editing scheme: exogenously adding spices containing linalool, citronellol, and geraniol. Specifically, during stewing process, compound spices containing 0.2% Sichuan peppercorns+0.02% bay leaves+0.03% star anise+0.05% cinnamon were added.
S6: Result output: GC-IMS technology was used to distinguish a flavor stable zone, a flavor enhancement zone, and a flavor compensation zone. Specifically, the characteristic flavor substances: 3-methylthiopropanal, 2-furfuryl alcohol, and 2-methyl-3-furanethiol generated through the Maillard reaction pathway, which have roasted and meaty flavors, were compensated, wherein the concentrations of 3-methylthiopropanal and 2-methyl-3-furanethiol were increased to 105% of the traditional characteristic flavor, and 2-furfuryl alcohol was compensated to 96% of the traditional characteristic flavor. The characteristic flavor substances derived from spices: linalool, citronellol and geraniol, which have floral and traditional Chinese medicine flavors, were enhanced, with concentrations being increased to 102% of the original concentrations. An overall flavor enhancement and flavor compensation effect was achieved. After storage, the flavor retention was good, and the sensory flavor wheel overlap before and after editing was >90%.

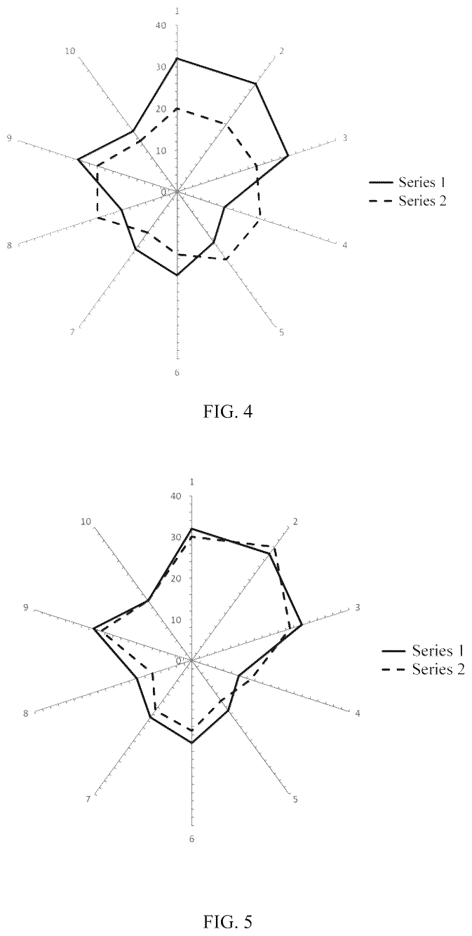

FIG. 4 is a characteristic flavor profile map before target-oriented flavor editing in the target-oriented flavor editing method for maintaining characteristic flavor of food provided by the present application.

FIG. 5 is a characteristic flavor profile map after target-oriented flavor editing in the target-oriented flavor editing method for maintaining characteristic flavor of food provided by the present application.

In FIGS. 4 and 5, the solid line represents the characteristic flavor profile map before flavor profile shifting, and the dashed line represents the characteristic flavor profile map after flavor profile shifting. As shown in FIG. 4, before target-oriented flavor editing, the product is unstable and the flavor is easily lost, resulting in significant shifting of the characteristic flavor profile. After target-oriented flavor editing, as shown in FIG. 5, an overall flavor enhancement and flavor compensation effect is achieved. After storage, the flavor retention is good, and the sensory flavor wheel overlap before and after editing is >90%.

### Case 2: Off-Flavor Editing Method: Off-Flavor Correction

S1: Change in the characteristic flavor profile of stewed beef was monitored.
S2: An analysis model of flavor profile shifting paths was invoked to determine the flavor profile shifting path that causes flavor profile shifting as off-flavor generation. Based on GC-MS technical analysis, the content of compounds such as hexanal produced by oxidative degradation of fats was significantly increased after storage/reheating, further supporting the above judgment.
S3: An off-flavor generation correction editing model was invoked for performing target-oriented flavor editing.
S4: Editing scheme output: 1) endogenous editing scheme: during pickling process, perilla leaves were added to perform flavor editing on the target dish by means of endogenous control; and 2) exogenous editing scheme: yeast extract was added to perform flavor editing on the target dish by means of exogenous adsorption.
S5: Result output: GC-MS results show that adding perilla leaves before stewing has a significant effect on removing off-flavor substances in pickling process, with an off-flavor correction rate of about 80%. The addition of yeast extract significantly reduces hexanal contents in freshly made stewed beef and reheated stewed beef, with a maximum reduction of 45%.

FIG. 6 is a schematic diagram of the off-flavor values before and after target-oriented flavor editing in the target-oriented flavor editing method for maintaining characteristic flavor of food provided by the present application. As shown in FIG. 6, the GC-MS results show that the addition of yeast extract FA62 significantly reduces the off-flavor value of stewed beef, which is basically restored to the level of freshly made stewed beef.

In the target-oriented flavor editing method for maintaining characteristic flavor of food provided by the present application, through intelligent monitoring/analysis of the change law of flavor quality deterioration caused by flavor profile change resulted from flavor escape, flavor inactivation, off-flavor generation, and the like in food production processing/storage and transportation/reheating process, determining multi-dimensional feature descriptors based on food multi-omics analysis in combination with molecular composition, configuration, conformation, electrochemical properties and the like, constructing a variety of target-oriented flavor editing models with the aid of artificial intelligence algorithms, making intelligent decisions, optimizing thermal reaction to produce aroma, food material property/food flavor interaction, aroma enrichment and flavoring with essence/spices and steady state maintenance, physical/chemical/biological off-flavor reduction in coordination with regulation paths and methods, target-oriented quantitative flavor enhancement, flavor compensation and off-flavor correction, intelligent targeted regulation of characteristic flavor retention of food is achieved.

The following describes the target-oriented flavor editing system for maintaining characteristic flavor of food provided by the present application. The target-oriented flavor editing system for maintaining characteristic flavor of food described below can be cross-referenced with the target-oriented flavor editing method for maintaining characteristic flavor of food described above.

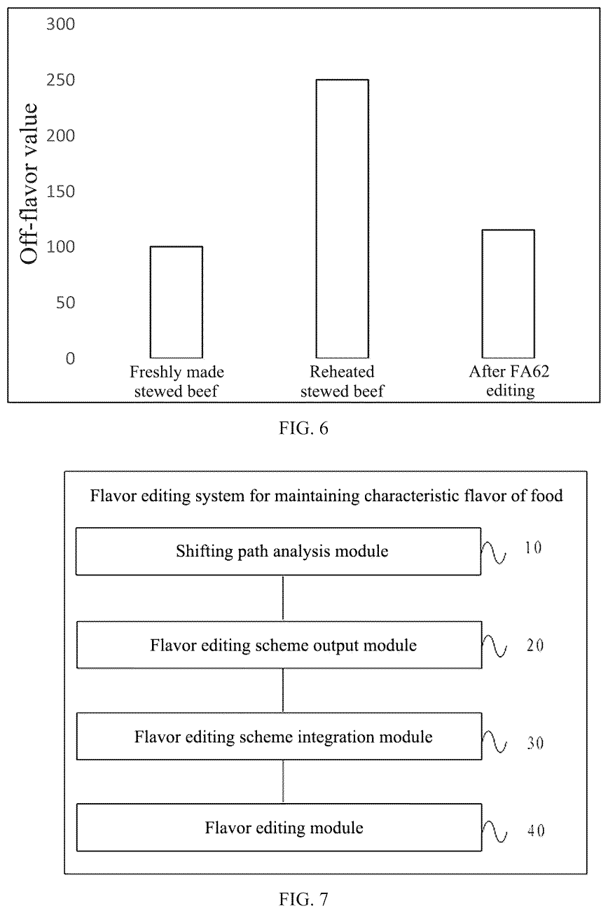

FIG. 7 is a schematic diagram of the structure of the target-oriented flavor editing system for maintaining characteristic flavor of food provided by the present application. As shown in FIG. 7, the system comprises a shifting path analysis module 10, a flavor editing scheme output module 20, a flavor editing scheme integration module 30, and a flavor editing module 40, wherein the shifting path analysis module 10 is used for: in response to monitoring that change in characteristic flavor profile of food exceeds a preset threshold, determining the occurrence of flavor profile shifting, and invoking an analysis model of flavor profile shifting paths to determine at least one flavor profile shifting path that causes flavor profile shifting. The flavor editing scheme output module 20 is used for: invoking a corresponding target-oriented flavor editing model, respectively, based on each flavor profile shifting path of the at least one flavor profile shifting path, and outputting a target-oriented flavor editing scheme for maintaining flavor for the corresponding flavor profile shifting path, respectively. The flavor editing scheme integration module 30 is used for: integrating the target-oriented flavor editing schemes output by the target-oriented flavor editing model corresponding to the at least one flavor profile shifting path, respectively, to obtain an integration result of the target-oriented flavor editing schemes. The flavor editing module 40 is used for: performing flavor editing on the food based on the integration result of the target-oriented flavor editing schemes.

In the target-oriented flavor editing system for maintaining characteristic flavor of food provided by the present application, in response to monitoring change in characteristic flavor profile of food exceeding a preset threshold, the occurrence of flavor profile shifting is determined, an analysis model of flavor profile shifting paths is invoked to determine at least one flavor profile shifting path that causes flavor profile shifting, a corresponding target-oriented flavor editing model is invoked, respectively, based on each flavor profile shifting path of the at least one flavor profile shifting path, a target-oriented flavor editing scheme for maintaining flavor for the corresponding flavor profile shifting path is output, respectively, the target-oriented flavor editing schemes output by the target-oriented flavor editing model corresponding respectively to the at least one flavor profile shifting path are integrated, to obtain an integration result of the target-oriented flavor editing schemes, and flavor editing is performed on the food based on the integration result of the target-oriented flavor editing schemes. Precise, highly efficient, and intelligent target-oriented regulation of characteristic flavor of food is achieved, and the effect of maintaining characteristic flavor of food is improved.

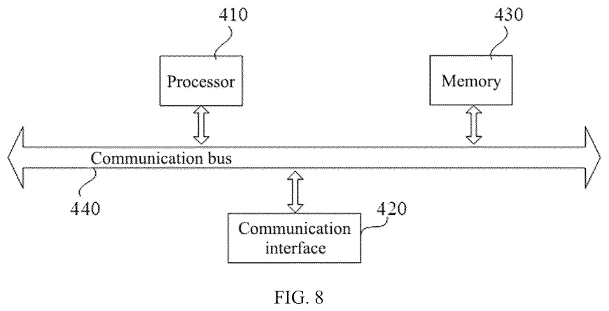

FIG. 8 shows a schematic diagram of the physical structure of an electronic device. As shown in FIG. 8, the electronic device may comprise a processor 410, a communication interface 420, a memory 430, and a communication bus 440, wherein the processor 410, the communication interface 420, and memory 430 communicate with each other through the communication bus 440. The processor 410 can call logic instructions in the memory 430 to execute a target-oriented flavor editing method for maintaining characteristic flavor of food. The method comprises: in response to monitoring that change in characteristic flavor profile of food exceeds a preset threshold, determining the occurrence of flavor profile shifting, and invoking an analysis model of flavor profile shifting paths to determine at least one flavor profile shifting path that causes flavor profile shifting; invoking a corresponding target-oriented flavor editing model, respectively, based on each flavor profile shifting path of the at least one flavor profile shifting path, and outputting a target-oriented flavor editing scheme for maintaining flavor for the corresponding flavor profile shifting path, respectively; integrating the target-oriented flavor editing schemes output by the target-oriented flavor editing model corresponding to the at least one flavor profile shifting path, respectively, to obtain an integration result of the target-oriented flavor editing schemes; and performing flavor editing on the food based on the integration result of the target-oriented flavor editing schemes.

In addition, the logic instructions in the aforementioned memory 430 can be implemented through the form of software functional units and can be stored in a computer-readable storage medium when sold or used as independent products. Based on this understanding, the part in essence or as a contribution to the prior art of the technical solution of the present application or part of the technical solution can be embodied in the form of a software product. The computer software product is stored in a storage medium and comprises a number of instructions to enable a computer device (which can be a personal computer, server, or network device, etc.) to perform all or part of the steps of the methods described in each embodiment of the present application. The aforementioned storage medium comprises various media that can store program code such as USB flash disk, mobile hard disk, read-only memory (ROM), random access memory (RAM), magnetic disks or optical disks.

On the other hand, the present application further provides a computer program product comprising a computer program that can be stored on a non transient computer-readable storage medium. When the computer program is executed by a processor, the computer can execute the target-oriented flavor editing method for maintaining characteristic flavor of food provided by the above methods. The method comprises: in response to monitoring that change in characteristic flavor profile of food exceeds a preset threshold, determining the occurrence of flavor profile shifting, and invoking an analysis model of flavor profile shifting paths to determine at least one flavor profile shifting path that causes flavor profile shifting; invoking a corresponding target-oriented flavor editing model, respectively, based on each flavor profile shifting path of the at least one flavor profile shifting path, and outputting a target-oriented flavor editing scheme for maintaining flavor for the corresponding flavor profile shifting path, respectively; integrating the target-oriented flavor editing schemes output by the target-oriented flavor editing model corresponding to the at least one flavor profile shifting path, respectively, to obtain an integration result of the target-oriented flavor editing schemes; and performing flavor editing on the food based on the integration result of the target-oriented flavor editing schemes.

On the other hand, the present application further provides a non transient computer-readable storage medium, on which a computer program is stored. When the computer program is executed by a processor, the target-oriented flavor editing method for maintaining characteristic flavor of food provided by the above methods are implemented. The method comprises: in response to monitoring that change in characteristic flavor profile of food exceeds a preset threshold, determining the occurrence of flavor profile shifting, and invoking an analysis model of flavor profile shifting paths to determine at least one flavor profile shifting path that causes flavor profile shifting; invoking a corresponding target-oriented flavor editing model, respectively, based on each flavor profile shifting path of the at least one flavor profile shifting path, and outputting a target-oriented flavor editing scheme for maintaining flavor for the corresponding flavor profile shifting path, respectively; integrating the target-oriented flavor editing schemes output by the target-oriented flavor editing model corresponding to the at least one flavor profile shifting path, respectively, to obtain an integration result of the target-oriented flavor editing schemes; and performing flavor editing on the food based on the integration result of the target-oriented flavor editing schemes.

The above-described embodiments of the device are only illustrative, where the units described as separate components may or may not be physically separated, and the components displayed as units may or may not be physical units, that is, they can be located in one place or distributed across multiple network units. Some or all of the modules can be selected according to actual needs to achieve the purpose of this embodiment. Ordinary technicians in the art can understand and implement without putting in creative effort.

Through the description of the above embodiments, technical personnel in the art can clearly understand that each embodiment can be implemented through software and necessary general hardware platforms, and of course, it can also be implemented through hardware. Based on this understanding, the part in essence or as a contribution to the prior art of the above-mentioned technical solution can be embodied in the form of a software product. The computer software product can be stored in computer-readable storage media such as ROM/RAM, magnetic disks, and optical disks, and comprises a number of instructions to enable a computer device (which can be a personal computer, server, or network device, etc.) to execute the methods described in each embodiment or some parts of the embodiment.

Finally, it should be noted that the above embodiments are only used to illustrate the technical solution of the present application, and not to limit it. Although the present application has been described in detail with reference to the aforementioned embodiments, those skilled in the art should understand that they can still modify the technical solutions described in the aforementioned embodiments, or equivalently replace some of the technical features. These modifications or replacements do not cause the essence of corresponding technical solutions to depart from the spirit and scope of technical solutions of the embodiments of the present application.

What is claimed is:

1. A target-oriented flavor editing method for maintaining characteristic flavor of food, comprising:
in response to monitoring that change in characteristic flavor profile of food exceeds a preset threshold, determining the occurrence of flavor profile shifting, and invoking an analysis model of flavor profile shifting paths to determine at least one flavor profile shifting path that causes flavor profile shifting;
invoking a corresponding target-oriented flavor editing model, respectively, based on each flavor profile shifting path of the at least one flavor profile shifting path, and outputting a target-oriented flavor editing scheme for maintaining flavor for the corresponding flavor profile shifting path, respectively;
integrating the target-oriented flavor editing schemes output by the target-oriented flavor editing model corresponding to the at least one flavor profile shifting path, respectively, to obtain an integration result of the target-oriented flavor editing schemes; and
performing flavor editing on the food based on the integration result of the target-oriented flavor editing schemes,
wherein invoking an analysis model of flavor profile shifting paths to determine at least one flavor profile shifting path that causes flavor profile shifting, comprises:
obtaining model input data, wherein the model input data includes material list data, processing method data, and data of change in the type and amount of compounds before and after flavor profile shifting of the food; and
loading the analysis model of flavor profile shifting paths, inputting the model input data into the analysis model of flavor profile shifting paths, and determining at least one flavor profile shifting path that causes flavor profile shifting based on an output result of the analysis model of flavor profile shifting paths;
wherein invoking a corresponding target-oriented flavor editing model, respectively, based on each flavor profile shifting path of the at least one flavor profile shifting path, and outputting a target-oriented flavor editing scheme for maintaining flavor for the corresponding flavor profile shifting path, respectively, comprises:
loading the target-oriented flavor editing model corresponding to the flavor profile shifting path, respectively, based on each flavor profile shifting path of the at least one flavor profile shifting path, inputting the model input data into the target-oriented flavor editing model, respectively, and obtaining a target-oriented flavor editing scheme for maintaining flavor for the corresponding flavor profile shifting path, respectively, based on the output of the target-oriented flavor editing model;
wherein the method further comprises:
obtaining first input data and first output data based on a food sample that has undergone flavor deterioration, wherein the first input data includes material list data, processing method data, data of change in the type and amount of compounds before and after flavor profile shifting, and preselected flavor profile shifting feature descriptors of the food sample, and wherein the first output data includes the flavor profile shifting path of the food sample;
using the first input data as the input of a first machine learning model, setting the output label of the first machine learning model based on the first output data, and iteratively training the first machine learning model; and
stopping training when the preset number of iterations is reached or the preset accuracy requirement for predicting the flavor profile shifting path is met, to obtain the analysis model of flavor profile shifting paths.

2. The target-oriented flavor editing method for maintaining characteristic flavor of food of claim 1, wherein when the flavor profile shifting path is flavor escape, the corresponding target-oriented flavor editing model is a flavor escape correction editing model, and the method further comprises:
obtaining second input data and second output data based on a food sample that has undergone flavor escape, wherein the second input data includes material list data, processing method data, data of change in the type and amount of compounds before and after flavor escape, and preselected flavor escape feature descriptors of the food sample, and wherein the second output data includes flavor escape correction editing schemes for maintaining characteristic flavor of the food sample;
using the second input data as the input of a second machine learning model, setting the output label of the second machine learning model based on the second output data, and iteratively training the second machine learning model; and
stopping training when the preset number of iterations is reached or the preset characteristic flavor retention requirement is met, to obtain the flavor escape correction editing model.

3. The target-oriented flavor editing method for maintaining characteristic flavor of food of claim 1, wherein when the flavor profile shifting path is flavor inactivation, the corresponding target-oriented flavor editing model is a flavor inactivation correction editing model, and the method further comprises:
obtaining third input data and third output data based on a food sample that has undergone flavor inactivation, wherein the third input data includes material list data, processing method data, data of change in the type and amount of compounds before and after flavor inactivation, and preselected flavor inactivation feature descriptors of the food sample, and wherein the third output data includes flavor inactivation correction editing schemes for maintaining characteristic flavor of the food sample;
using the third input data as the input of a third machine learning model, setting the output label of the third machine learning model based on the third output data, and iteratively training the third machine learning model; and
stopping training when the preset number of iterations is reached or the preset characteristic flavor retention requirement is met, to obtain the flavor inactivation correction editing model.

4. The target-oriented flavor editing method for maintaining characteristic flavor of food of claim 1, wherein when the flavor profile shifting path is off-flavor generation, the corresponding target-oriented flavor editing model is an off-flavor generation correction editing model, and the method further comprises:
obtaining fourth input data and fourth output data based on a food sample that has undergone off-flavor generation, wherein the fourth input data includes material list data, processing method data, data of change in the type and amount of compounds before and after off-flavor generation, and preselected off-flavor generation feature descriptors of the food sample, and wherein the fourth output data includes off-flavor generation correction editing schemes for maintaining characteristic flavor of the food sample;
using the fourth input data as the input of a fourth machine learning model, setting the output label of the fourth machine learning model based on the fourth output data, and iteratively training the fourth machine learning model; and
stopping training when the preset number of iterations is reached or the preset characteristic flavor retention requirement is met, to obtain the off-flavor generation correction editing model.

5. The target-oriented flavor editing method for maintaining characteristic flavor of food of claim 1, wherein after performing flavor editing on the food based on the integration result of the target-oriented flavor editing schemes, the method further comprises:
obtaining and displaying a flavor editing result.

6. A target-oriented flavor editing system for maintaining characteristic flavor of food based on the target-oriented flavor editing method for maintaining characteristic flavor of food of claim 1, comprising:
a drift path analysis module, which is used for: in response to monitor that change in characteristic flavor profile of food exceeds a preset threshold, determining the occurrence of flavor profile shifting, and invoking an analysis model of flavor profile shifting paths to determine at least one flavor profile shifting path that causes flavor profile shifting;
a flavor editing scheme output module, which is used for: invoking a corresponding target-oriented flavor editing model, respectively, based on each flavor profile shifting path of the at least one flavor profile shifting path, and outputting a target-oriented flavor editing scheme for maintaining flavor for the corresponding flavor profile shifting path, respectively;
an integration module, which is used for: integrating the target-oriented flavor editing schemes output by the target-oriented flavor editing model corresponding to the at least one flavor profile shifting path, respectively, to obtain an integration result of the target-oriented flavor editing schemes; and
a flavor editing module, which is used for: performing flavor editing on the food based on the integration result of the target-oriented flavor editing schemes.

7. An electronic device, comprising a memory, a processor, and a computer program stored on the memory and executable on the processor, wherein when the processor executes the program, the target-oriented flavor editing method for maintaining characteristic flavor of food of claim 1 is implemented.

8. A non transient computer-readable storage medium, on which a computer program is stored, wherein when the computer program is executed by a processor, the target-oriented flavor editing method for maintaining characteristic flavor of food of claim 1 is implemented.
